(19) United States
(12) Patent Application Publication
(10) Pub. No.: US 2008/0031991 A1
(43) Pub. Date: Feb. 7, 2008

(54) INJECTION MOLD FOR GLASS ENCAPSULATION

(75) Inventors: Sung Choi, Gyeonggi-do (KR); O Yeol Kwon, Daegu-si (KR); Alexander Hong Nahm, Gyeongsangbug-so (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Moya International Co., Ltd., Gyeongsangbug-do (KR)

(21) Appl. No.: 11/461,986

(22) Filed: Aug. 2, 2006

(51) Int. Cl. B29C 47/96; B29C 45/00; B28B 17/00

(52) U.S. Cl. 425/149; 425/542

(57) ABSTRACT

Disclosed herein is an injection mold for glass encapsulation, which has a variable support unit connected to a pressure control unit so as to support a glass panel with a constant force. The injection mold for glass encapsulation is constructed to put a glass panel between upper and lower molds and integrally form a mold along an edge of the glass panel. The injection mold includes a support unit supporting a lower portion of the glass panel and moving up and down along a support recess which is defined in the lower mold, a shock absorbing unit having a cylinder to press and support the support unit using elastic force, and a pressure control unit maintaining hydraulic pressure in the cylinder at a preset pressure.

### BACKGROUND OF THE INVENTION

1. Field of the Invention

The present invention relates generally to an injection mold for glass encapsulation and, more particularly, to an injection mold for glass encapsulation, which has a variable support unit connected to a pressure control unit so as to support a glass panel with a constant force.

2. Description of the Related Art

Generally, a sunroof glass panel or a side fixed glass panel for vehicles is integrated with a synthetic resin mold having a predetermined shape so as to increase the strength of the glass panel and to allow the glass panel to be efficiently coupled to a packing.

As such, the process wherein the synthetic resin mold is integrated with the edge of the glass panel is referred to as glass encapsulation.

Hereinafter, a conventional injection mold for glass encapsulation will be described with reference to the accompanying drawings.

FIG. 1 is a sectional view showing a conventional injection mold for glass encapsulation, FIG. 2 is a view showing the state where a ruptured part is formed when the curvature of a glass panel of FIG. 1 has a positive tolerance, FIG. 3 is a view showing the state where a burr is formed when the curvature of the glass panel of FIG. 1 has a negative tolerance, and FIG. 4 is a sectional view showing another conventional injection mold for glass encapsulation.

As shown in FIG. 1, the glass panel 5 is placed between an upper mold 1 and a lower mold 3. The upper mold 1 moves downwards to close the mold. Molten synthetic resin is injected along the edge of the glass panel 5.

Thereby, an injection molding process is performed while the synthetic resin mold 7 is secured to the edge of the glass panel 5.

However, the curvature of the glass panel 5 is not constant. Thus, in the case where the curvature or size of the glass panel 5 is large, manufacturing defects may occur when the upper mold 1 is closed.

That is, as shown in FIG. 2, when the curvature of the glass panel 5 is a positive tolerance, the upper mold 1 pressurizes the glass panel 5, so that a ruptured part 8 is formed, and the glass panel may break.

Further, as shown in FIG. 3, when the curvature of the glass panel 5 is a negative tolerance, a gap is formed between the glass panel 5 and the upper mold 1. Thereby, the synthetic resin mold 7 leaks into the area of the glass panel 5, so that a burr 9 is formed.

In order to solve the problems, a shock absorbing means for absorbing the tolerance of the glass panel has been proposed.

As shown in FIG. 4, the injection mold is provided with an upper mold 10 and a lower mold 12. A slider recess 17 having a predetermined height is defined in the lower mold 12.

Further, the injection mold has a slider 16 which moves up and down along the slider recess 17. A glass panel 14 is placed on the slider 16.

Stoppers 18 and springs 19 are installed under the slider 16. The stoppers 18 limit the downward moving distance of the slider 16. The springs 19 elastically support the slider 16.

Meanwhile, in order to limit the upward movement of the slider 16, a tolerance control unit 15 is provided between the bottom of the slider 16 and the bottom of the lower mold 12.

However, since the stoppers 18 are vertically installed to the bottom of the slider recess 17, a lot of space is required under the slider 16, which is undesirable. Further, the tolerance control unit 15 is mounted to the bottom of the lower mold 12, and thus is difficult to assemble and control. Furthermore, since the elastic force of each spring 19 fitted over the corresponding stopper 18 varies the longer it is used, it is difficult to precisely compensate for the tolerance of the glass panel 14. Therefore, these problems must be solved.

### SUMMARY OF THE INVENTION

Accordingly, the present invention has been made keeping in mind the above problems occurring in the prior art, and the present invention provides an injection mold for glass encapsulation, which is constructed to put a glass panel between upper and lower molds and to integrally form a mold along an edge of the glass panel, the injection mold including a support unit supporting a lower portion of the glass panel and moving up and down along a support recess which is defined in the lower mold, a shock absorbing unit having a cylinder to press and support the support unit using elastic force, and a pressure control unit maintaining hydraulic pressure in the cylinder at a preset pressure.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional injection mold for glass encapsulation;

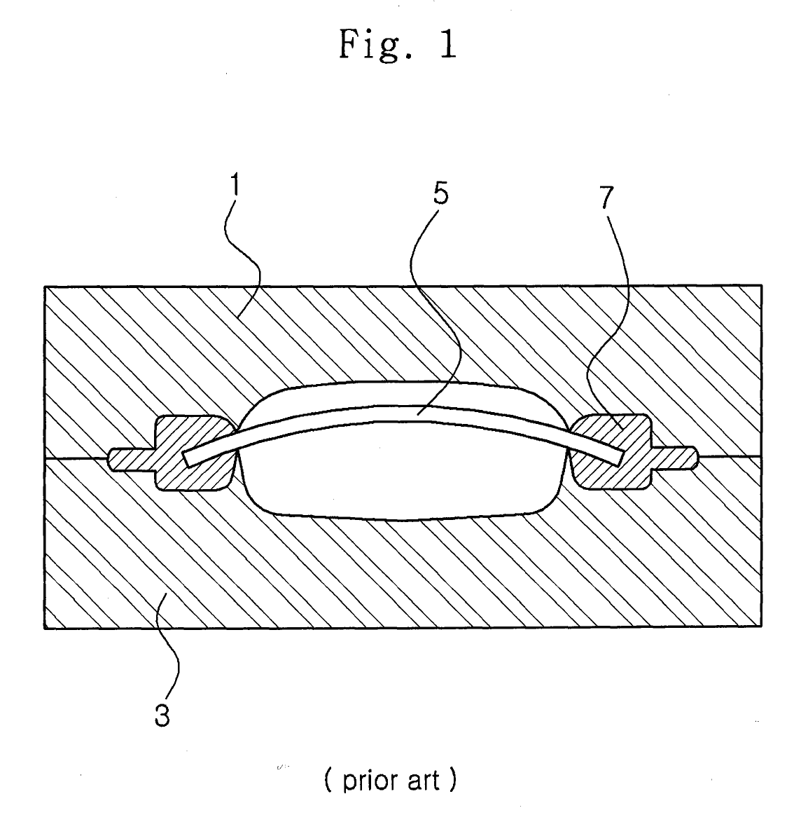

FIG. 2 is a view showing the state where a ruptured part is formed when the curvature of a glass panel of FIG. 1 has a positive tolerance;

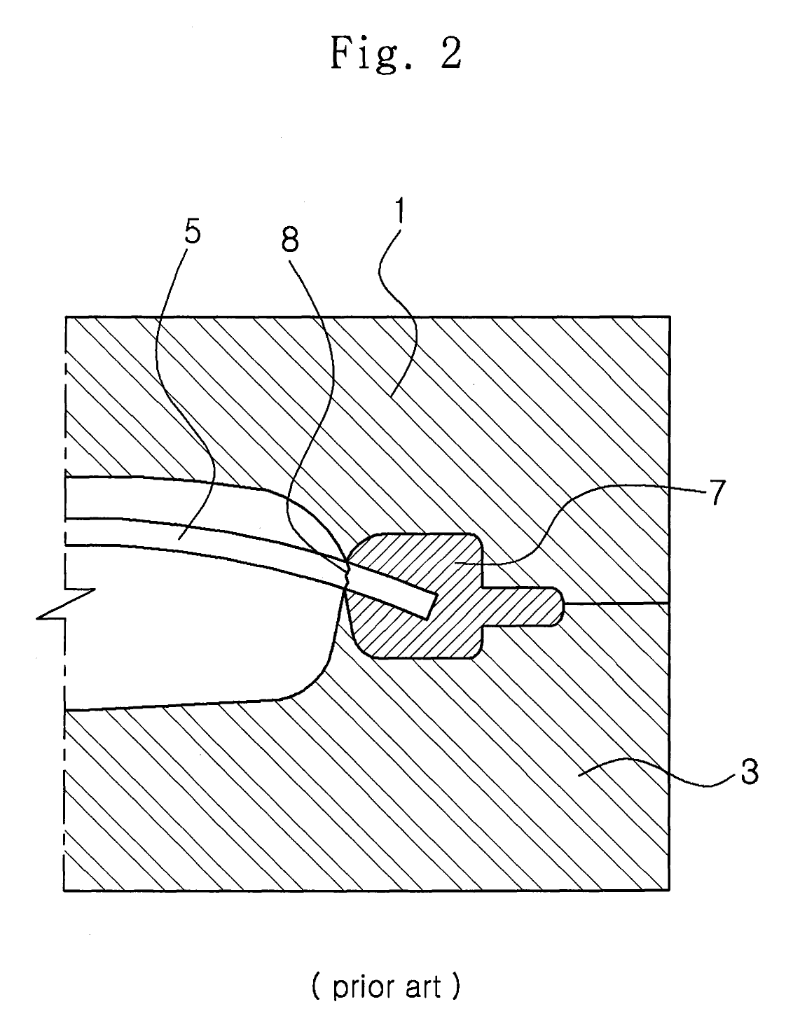

FIG. 3 is a view showing the state where a burr is formed when the curvature of the glass panel of FIG. 1 has a negative tolerance;

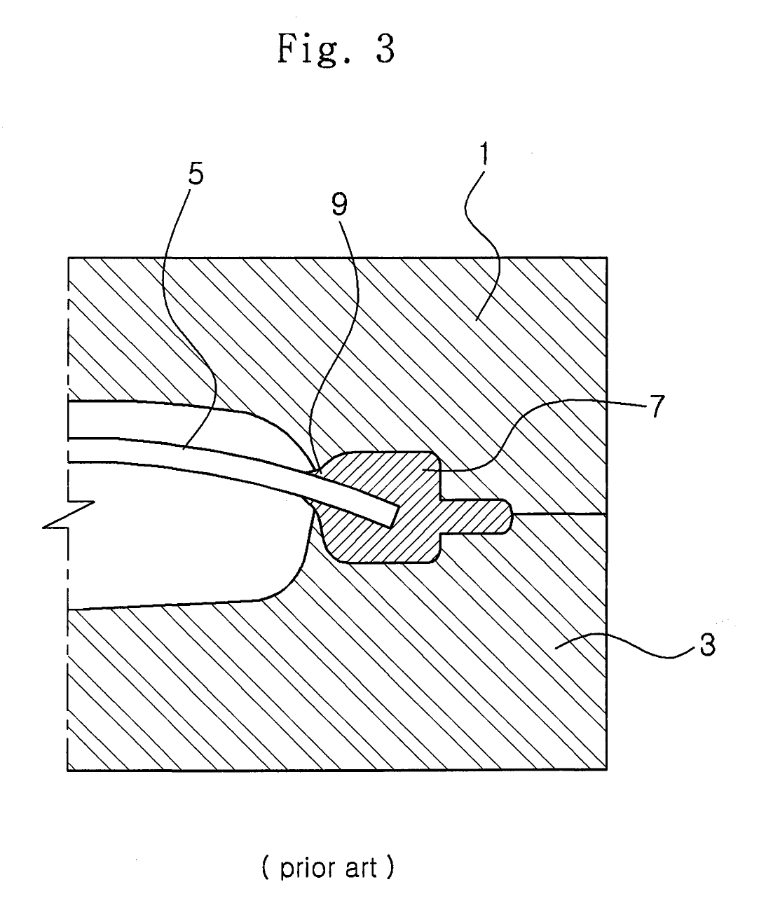

FIG. 4 is a sectional view showing another conventional injection mold for glass encapsulation;

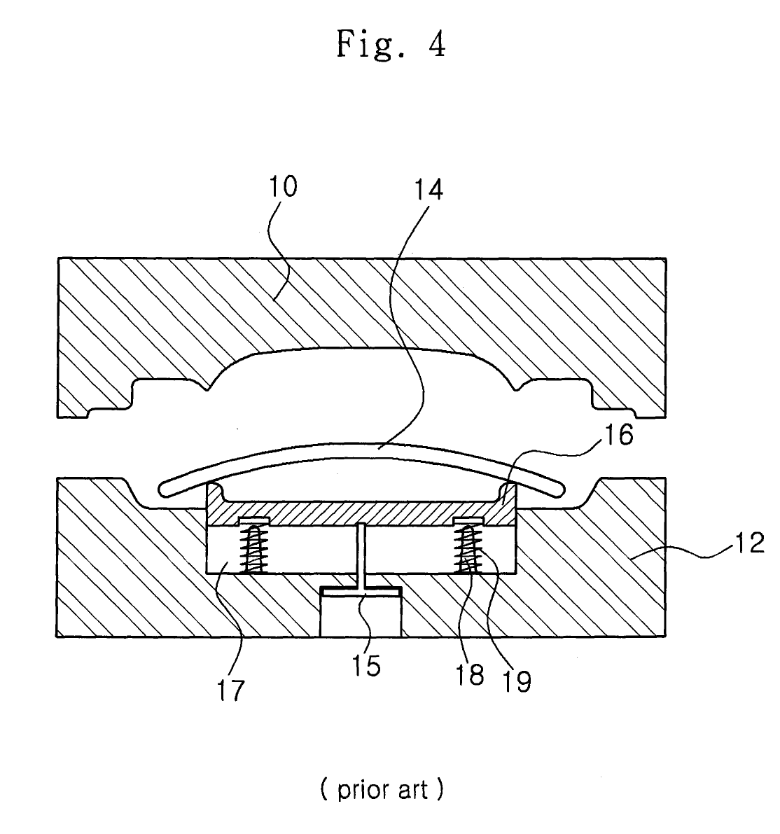

FIG. 5 is a view showing an injection mold for glass encapsulation, according to an embodiment of the present invention;

FIG. 6 is a view showing the operation of the injection mold for glass encapsulation of FIG. 5;

FIG. 7 is an enlarged view of portion “A” of FIG. 5;

FIG. 8 is a view schematically showing the construction of a shock absorbing unit and a pressure control unit of FIG. 5;

FIG. 9 is a view showing an injection mold for glass encapsulation, according to another embodiment of the present invention; and

FIG. 10 is a view showing the operation of the injection mold for glass encapsulation of FIG. 9.

### DESCRIPTION OF THE PREFERRED EMBODIMENTS

An injection mold for glass encapsulation according to the present invention is constructed to put a glass panel between upper and lower molds and to integrally form a mold along an edge of the glass panel. In this case, the injection mold includes a support unit which supports a lower portion of the glass panel and moves up and down along a support recess defined in the lower mold, a shock absorbing unit which has a cylinder to press and support the support unit using elastic force, and a pressure control unit which maintains hydraulic pressure in the cylinder at a preset pressure.

Preferably, a pressure sensor is mounted to a portion of the support unit contacting the glass panel, and transmits a measured value to the pressure control unit.

Further, a guide member is installed to pass through the support unit and is secured to a bottom of the support recess, the guide member guiding vertical motion of the support unit.

Further, fluid used in the cylinder and the pressure control unit is air.

The pressure control unit includes a main pipe which is connected at a first end thereof to a compression chamber for compressing the fluid using a piston of the cylinder, a valve member which is connected to a second end of the main pipe and connects the main pipe to an outlet pipe so as to discharge the fluid from the main pipe, or connects the main pipe to an inlet pipe so as to feed the fluid into the main pipe, or closes the main pipe, a fluid generator which is connected to the valve member and supplies the fluid to the piston, in response to an operation signal, and a control unit for controlling operation of the fluid generator and the valve member.

Further, the valve member comprises a three-way valve.

The injection mold includes an auxiliary pipe which extends from a side of the main pipe, and a measurement sensor which is provided at a predetermined position of the auxiliary pipe and measures pressure of the fluid.

The injection mold includes a holding part which contacts the lower portion of the glass panel and holds the glass panel using a vacuum, a coupling pipe which is connected at a first end thereof to the holding part and is installed to pass through the support unit and the lower mold, and a vacuum pump which is connected to a second end of the coupling pipe and creates a vacuum.

The injection mold includes a locking protrusion which is provided at a predetermined position of either of the upper and lower molds and has a shape of a trapezoid having an inclined surface which is tapered, and a locking hole which is formed to correspond to the locking protrusion and engages with the locking protrusion.

According to the present invention, when the glass panel is elastically pressurized and supported, the internal pressure of the cylinder and the pressure transmitted to the support unit by the glass panel are measured, thus controlling the internal pressure of the cylinder, therefore a molding operation is more precisely performed.

Hereinafter, an injection mold for glass encapsulation according to the preferred embodiments of the present invention will be described with reference to the accompanying drawings. For ease and convenience of description, the thickness of lines and the size of components in the drawings may be exaggerated. Further, the terms used herein are defined in consideration of the function of this invention, and may be varied according to the user's intention. Therefore, the terms should be defined based on the overall contents of the invention.

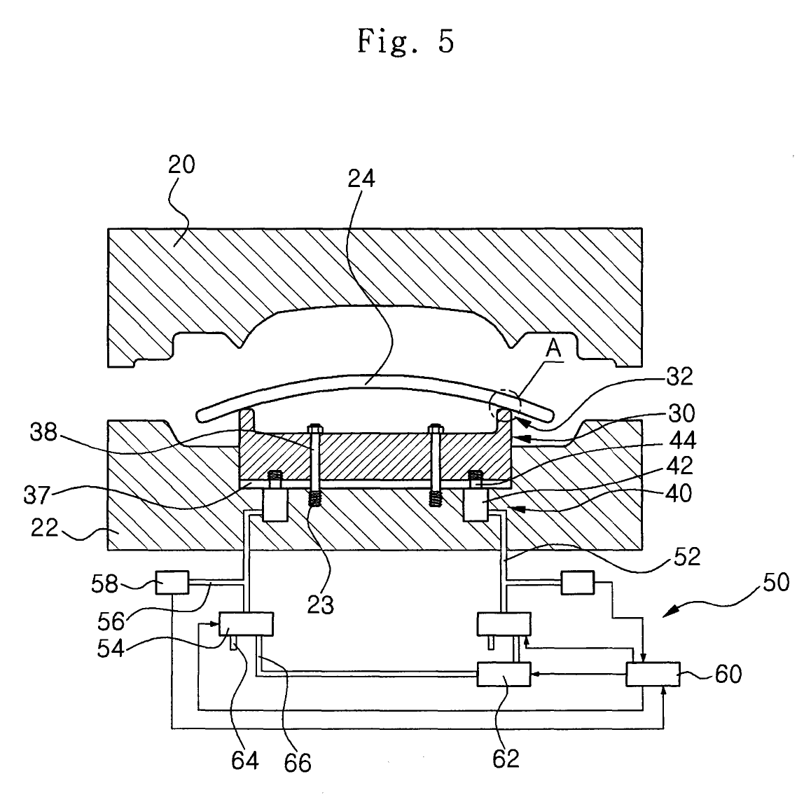

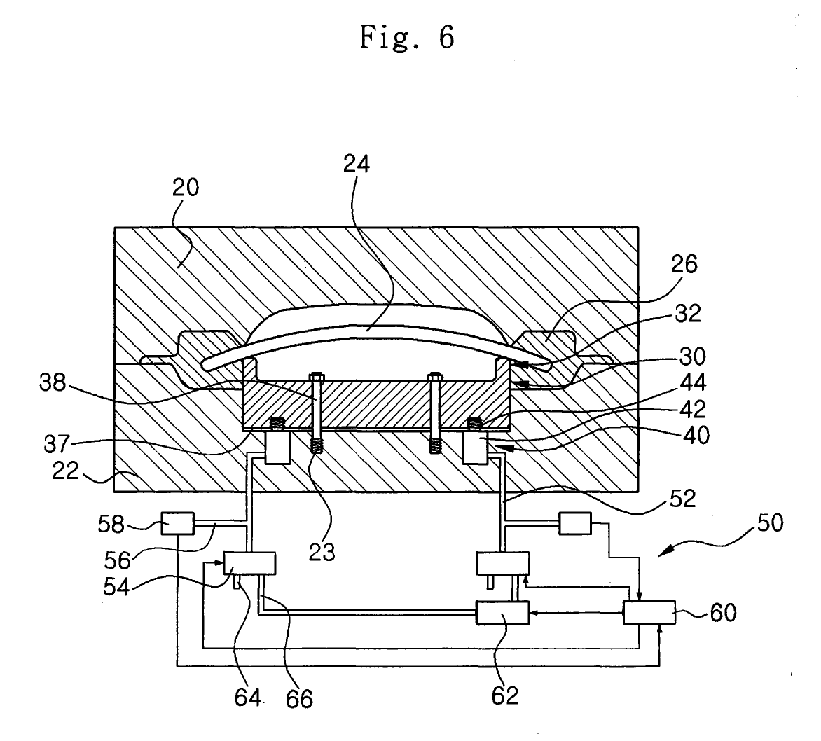

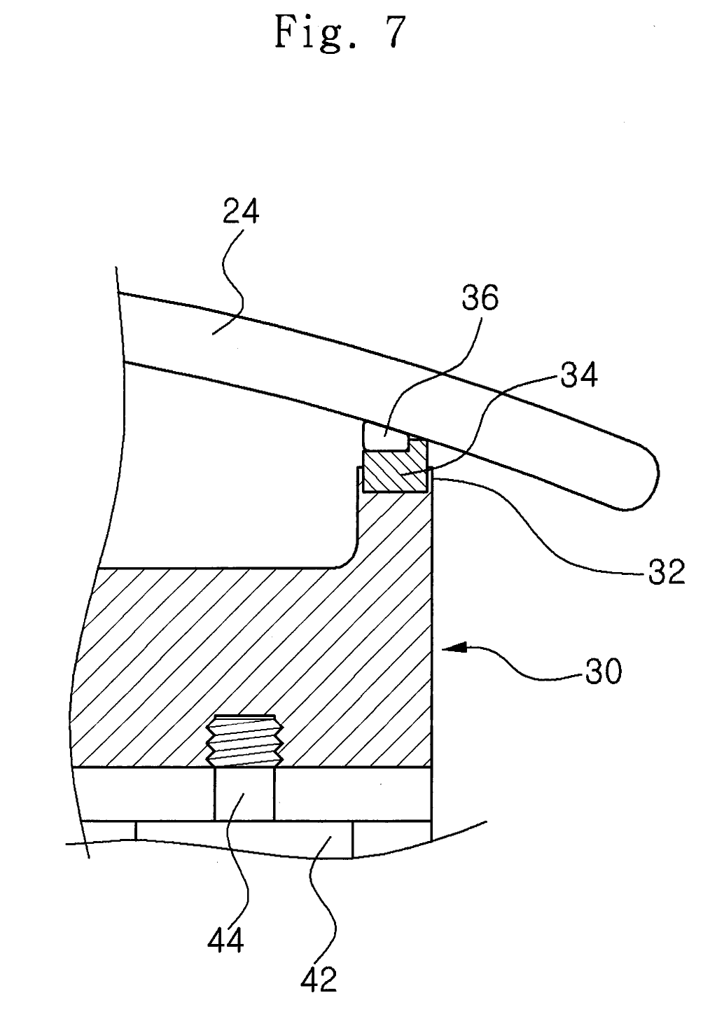

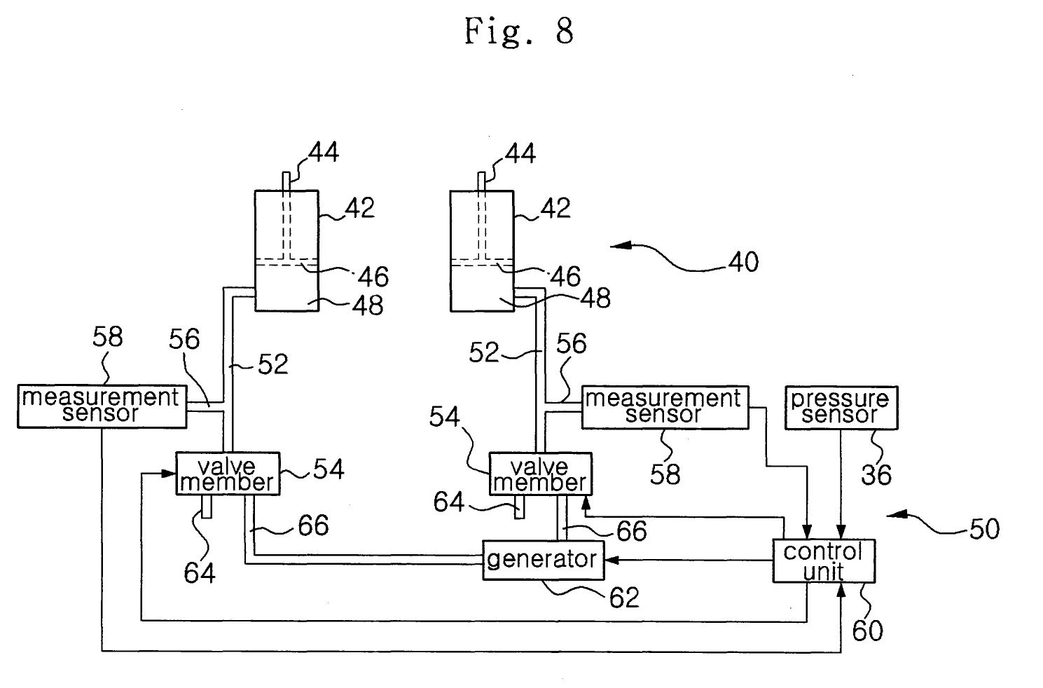

FIG. 5 is a view showing an injection mold for glass encapsulation, according to an embodiment of the present invention, FIG. 6 is a view showing the operation of the injection mold for glass encapsulation of FIG. 5, FIG. 7 is an enlarged view of portion “A” of FIG. 5, and FIG. 8 is a view schematically showing the construction of a shock absorbing unit and a pressure control unit of FIG. 5.

As shown in FIG. 5, a glass panel 24 is placed between an upper mold 20, which is movable up and down, and a lower mold 22, which is fixed at a predetermined position.

A support unit 30, which supports the lower portion of the glass panel 24, moves up and down along a support recess 37 defined in the lower mold 22.

The support unit 30 includes support protrusions 32 which protrude along the edge of the glass panel 24.

As shown in FIG. 7, elastic members 34 made of rubber are mounted to the corresponding support protrusions 32, thus absorbing shocks which are transmitted to the glass panel 24.

Further, a pressure sensor 36 is installed above each elastic member 34 which contacts the glass panel 24, and measures the pressure transmitted through the glass panel 24 to the support unit 30.

In order to increase the accuracy of measurement, the pressure sensor 36 may be directly mounted to each support protrusion 32 without the elastic member 34.

Further, guide members 38 installed to pass through the support unit 30 have the shape of a bolt. The lower end of each guide member 38 is fastened to each of fastening holes 23 formed in the bottom of the support recess 37, thus guiding the vertical movement of the support unit 30. Further, the upper end of each guide member 38 has the shape of a bolt head, thus limiting the upward movement of the support unit 30 to a preset height.

As shown in FIG. 5, the support unit 30 constructed as described above is elastically pressed and supported by shock absorbing units 40, each having a cylinder 42.

One end of a rod 44 of each cylinder 42 is fastened to the support unit 30, and the other end of the rod 44 is connected to a piston 46, as shown in FIG. 8.

A compression chamber 48 filled with fluid is provided under the piston 46, as seen in FIG. 8. The vertical movement of the piston 46 changes the pressure of fluid contained in the compression chamber 48.

The shock absorbing units 40 each having the cylinder 42 and a pressure control unit 50 for controlling the pressure of fluid fed into each cylinder 42 may use different fluid, such as gas or oil. According to this embodiment, air, which is environment-friendly and is inexpensive, is used.

The pressure control unit 50 measures the pressure of fluid contained in each cylinder 42. At this time, when the pressure is below a preset level, the fluid is replenished. Conversely, when the pressure exceeds the preset level, the pressure is lowered. In this way, the pressure of the fluid contained in each cylinder 42 is maintained at the preset level.

The construction of the pressure control unit 50 will be described with reference to FIG. 8.

One end of a main pipe 52 is connected to each compression chamber 48, in which fluid is compressed by the piston 46 of the corresponding cylinder 42.

The other end of the main pipe 52 is connected to a valve member 54. The valve member 54 is operated in response to an operation signal from a control unit 60.

The valve member 54 includes an outlet pipe 64 and an inlet pipe 66. The outlet pipe 64 is used to discharge fluid from the main pipe 52 to the outside. The inlet pipe 66 is used to feed fluid through the main pipe 52 to the compression chamber 48.

The valve member 54 connects the main pipe 52 to the outlet pipe 64 or the inlet pipe 66, or closes the main pipe 52, in response to an operation signal. As such, the valve member 54 may be changed to one of three positions.

The valve member 54 comprises a three-way valve. Since the detailed construction of the valve member 54 is known to those skilled in the art, it will not be described in detail herein.

An air pressure generator 62 is connected to the inlet pipes 66. The air pressure generator 62 is operated in response to an operation signal from the control unit 60, thus supplying fluid to each piston 46.

Since the air pressure generator 62 is a known component, it will not be described in detail herein.

Further, a measurement sensor 58 for measuring the pressure of fluid contained in each compression chamber 48 is mounted to a predetermined portion of an auxiliary pipe 56 which extends from one side of each main pipe 52. A value measured by the measurement sensor 58 is transmitted to the control unit 60.

The number of cylinders 42 or other components of the shock absorbing units 40 and the pressure control unit 50 constructed as described above is increased or reduced according to the size of the support unit 30 or the load.

Values measured by the pressure sensor 36 and the measurement sensors 58 are transmitted to the control unit 60. When it is determined that pressure of the fluid contained in each compression chamber 48 is below a preset level, the control unit 60 drives the air pressure generator 62, thus generating a hydraulic pressure.

Further, when the operation signal is transmitted to each valve member 54 to connect the main pipe 52 to the inlet pipe 66, a preset hydraulic pressure is supplied to each compression chamber 48.

When each compression chamber 48 is maintained at a proper hydraulic pressure, the valve member 54 is controlled by the control unit 60 so that the valve member 54 does not operate, thus closing the main pipe 52.

Meanwhile, when the hydraulic pressure of each compression chamber 48 is higher than a preset pressure, the operation signal is transmitted to each valve member 54, thus causing each main pipe 52 to be connected to the corresponding outlet pipe 64. Thereby, some of the fluid is discharged from each compression chamber 48.

In the injection mold for glass encapsulation constructed as described above, as shown in FIG. 6, when the upper mold 20 moves downwards to press the glass panel 24, the pressure control unit 50 is operated based on the values which are input by the pressure sensor 36 and the measurement sensors 58. Thus, the shock absorbing units 40 support the support unit 30 with a proper pressure.

Thereby, the support unit 30 moves a predetermined distance along the guide members 38. In such a state, a mold 26 is formed on the edge of the glass panel 24 through injection molding.

Hereinafter, an injection mold for glass encapsulation according to another preferred embodiment of the present invention will be described with reference to the accompanying drawings.

For the convenience of description, components common to both of the embodiments will carry the same reference numerals, and will not be described in detail herein.

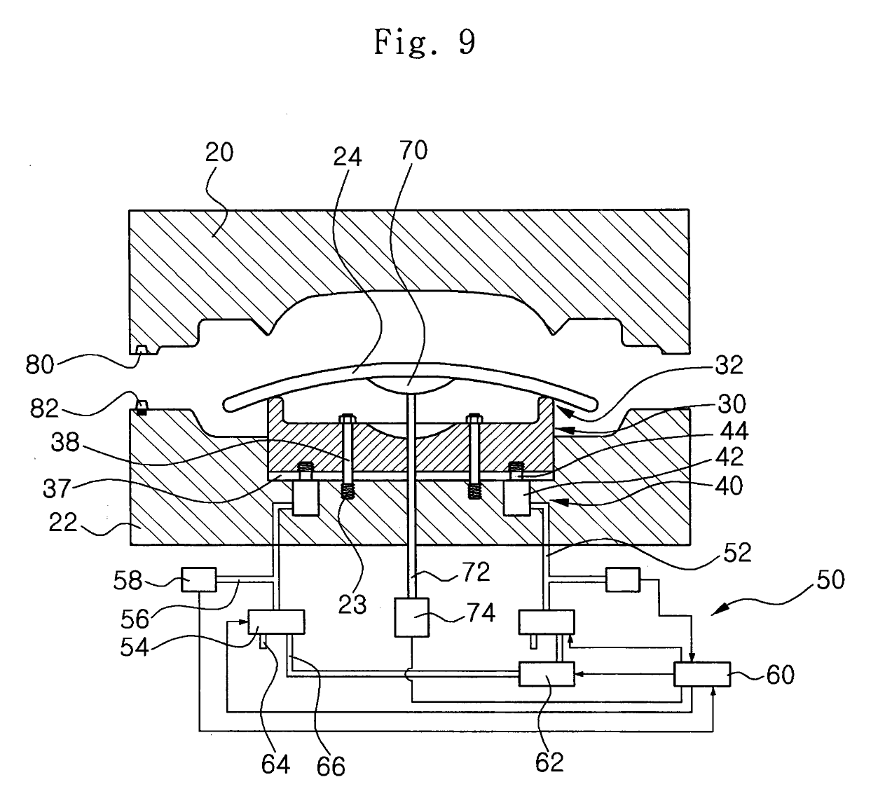

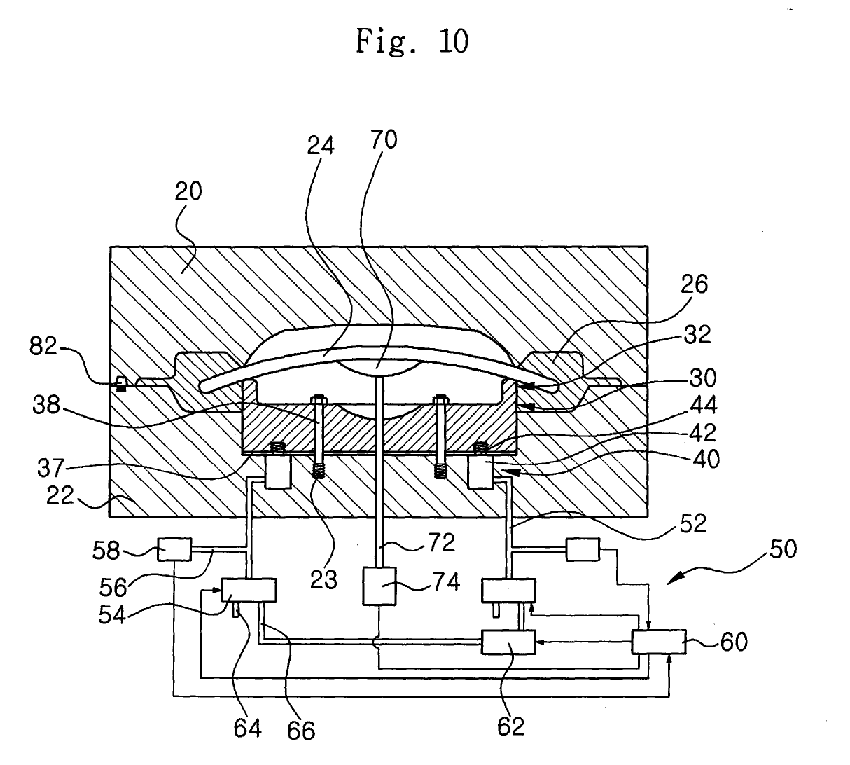

FIG. 9 is a view showing an injection mold for glass encapsulation, according to another embodiment of the present invention, and FIG. 10 is a view showing the operation of the injection mold for glass encapsulation of FIG. 9.

In order to prevent a glass panel 24 from slipping over a support unit 30 when an upper mold 20 moves downwards to press the glass panel 24, a disc-shaped holding part 70 made of rubber is provided on the bottom of the glass panel 24.

The holding part 70 is provided to contact the lower surface of the glass panel 24, and holds the glass panel 24 using a vacuum.

A coupling pipe 72 is coupled at one end thereof to the holding part 70, and passes through the support unit 30 and a lower mold 22.

A vacuum pump 74 is coupled to the other end of the coupling pipe 72 to create a vacuum. The vacuum pump 74 is connected to a control unit 60, so that an operation signal is transmitted from the control unit 60 to the vacuum pump 74.

In the state where the glass panel 24 comes into close contact with the holding part 70, the vacuum pump 74 is operated. At this time, the glass panel 24 is secured to a predetermined position by a vacuum, which is created in the holding part 70.

Further, in order to prevent the removal or slippage of the upper mold 20 and the lower mold 22, a locking hole 80 and a locking protrusion 82 are provided on the upper mold 20 and the lower mold 22, respectively.

The locking protrusion 82 has on an upper portion thereof a trapezoidal head having an inclined surface which is gradually tapered. Further, the locking protrusion 82 has on a lower portion thereof a threaded part to be secured to the upper mold 20 or the lower mold 22.

Further, a hole is formed in the upper mold 20 or the lower mold 22 to correspond to the locking protrusion 82. In this way, the locking hole 80 engaging with the locking protrusion 82 is formed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As described above, the present invention provides an injection mold for glass encapsulation, which includes a pressure control unit for controlling the pressure in a shock absorbing unit, unlike the prior art, thus precisely absorbing the tolerance of a glass panel, therefore having high operational reliability.

Further, even if the elastic force supporting the glass panel changes as time passes, it is compensated for by the pressure control unit, thus preventing the edge of the glass panel from breaking or preventing a burr from forming on the edge of the glass panel, therefore reducing the defective rate of production and increasing productivity.

What is claimed is:

1. An injection mold for glass encapsulation, constructed to put a glass panel between upper and lower molds and to integrally form a mold along an edge of the glass panel, the injection mold comprising:
a support unit supporting a lower portion of the glass panel, and moving up and down along a support recess which is defined in the lower mold;
a shock absorbing unit having a cylinder, and pressing and supporting the support unit using elastic force; and
a pressure control unit maintaining hydraulic pressure in the cylinder at a preset pressure.

2. The injection mold as set forth in claim 1, wherein a pressure sensor is mounted to a portion of the support unit contacting the glass panel, and transmits a measured value to the pressure control unit.

3. The injection mold as set forth in claim 1, wherein a guide member is installed to pass through the support unit and is secured to a bottom of the support recess, the guide member guiding vertical motion of the support unit.

4. The injection mold as set forth in claim 1, wherein fluid used in the cylinder and the pressure control unit is air.

5. The injection mold as set forth in claim 1, wherein the pressure control unit comprises:
a main pipe connected at a first end thereof to a compression chamber for compressing the fluid using a piston of the cylinder;
a valve member connected to a second end of the main pipe, the valve member connecting the main pipe to an outlet pipe so as to discharge the fluid from the main pipe, or connecting the main pipe to an inlet pipe so as to feed the fluid into the main pipe, or closing the main pipe, in response to an operation signal;
a fluid generator connected to the valve member, and supplying the fluid to the piston, in response to an operation signal; and
a control unit for controlling operation of the fluid generator and the valve member.

6. The injection mold as set forth in claim 5, wherein the valve member comprises a three-way valve.

7. The injection mold as set forth in claim 5, comprising:
an auxiliary pipe extending from a side of the main pipe; and
a measurement sensor provided at a predetermined position of the auxiliary pipe, and measuring pressure of the fluid.

8. The injection mold as set forth in claim 1, comprising:
a holding part contacting the lower portion of the glass panel, and holding the glass panel using a vacuum;
a coupling pipe connected at a first end thereof to the holding part, and installed to pass through the support unit and the lower mold; and
a vacuum pump connected to a second end of the coupling pipe, and creating a vacuum.

9. The injection mold as set forth in claim 1, comprising:
a locking protrusion provided at a predetermined position of either of the upper and lower molds, and having a shape of a trapezoid having an inclined surface which is tapered; and
a locking hole formed to correspond to the locking protrusion, and engaging with the locking protrusion.
